(19) United States
(12) Patent Application Publication
(10) Pub. No.: US 2011/0174087 A1
(43) Pub. Date: Jul. 21, 2011

(54) PIPETTE DEVICE

(76) Inventors: Shoichi Kimura, Kobe (JP); Kazuho Takayanagi, Kobe (JP); Makoto Takehara, Kobe (JP)

(21) Appl. No.: 12/967,124

(22) Filed: Dec. 14, 2010

(30) Foreign Application Priority Data
Jan. 20, 2010 (JP) 2010-010215

(51) Int. Cl. B01L 3/02

(52) U.S. Cl. 73/864.01

(57) ABSTRACT

There is provided a pipette device adaptable to a decrease in diameter of a pipette main body and costing lower. A pipette device 1 in which a plunger 3 is inserted in a cylinder portion “a” of a pipette main body 2 to be movable in an axial direction and the plunger 3 is moved to change a cylinder volume includes seal ring portions 15c, 15d formed on and integrally with one of an inner peripheral surface of the cylinder portion “a” and an outer peripheral surface of the plunger 3 to seal a gap between the cylinder portion “a” and the plunger 3.

### BACKGROUND OF THE INVENTION

1. Field of the Invention

The present invention relates to a pipette device for collecting a predetermined amount of a sample (liquid) used for inspection, analysis, experiments, and the like.

2. Description of the Related Art

When a sample is inspected, analyzed, subjected to experiment, or the like, a predetermined amount of a sample is sucked by negative pressure generated by a plunger movably inserted in a pipette main body to collect the sample in a pipette tip, and the sample in the pipette tip is injected to a device for inspection, analysis, or the like. If air leaks from a gap between the pipette main body and the plunger when the sample is sucked in to be collected, a collection amount changes, which hinders the accurate collection of the sample.

To prevent the change in the collection amount due to the leakage of air, an O-ring sealing the gap between the pipette main body and the plunger is fitted therebetween, in, for example, Japanese Patent Application Laid-open No. Hei 6-210188.

### SUMMARY OF THE INVENTION

One problem of the structure using the O-ring for sealing in the conventional example is that it is not adaptable to a decrease in diameter of the pipette main body, and another problem is that the O-ring increases cost. Specifically, when a small amount of a sample is collected or when a sample is collected at a time by a device including a large number of pipette tips, a pipette main body with a small cylinder volume is used. In this case, a diameter of the plunger is decreased in accordance with the decrease in diameter of the pipette main body. Therefore, it is likely that reserving space to fit the O-ring in is difficult, or the fitting itself of the O-ring is difficult.

The present invention has been developed in consideration of the above conventional circumstances and has an object to provide a pipette device adaptable to a decrease in diameter of a pipette main body and costing lower.

The present invention is a pipette device which includes: a pipette main body having a cylinder portion; a plunger disposed in an inserted state in the cylinder portion to be movable in an axial direction and changing a cylinder volume; and a push rod which is inserted in the pipette main body to be movable in the axial direction and moves the plunger to change the cylinder volume, the pipette device including a seal ring portion formed on and integrally with one of an inner peripheral surface of the cylinder portion and an outer peripheral surface of the plunger to seal a gap between the cylinder portion and the plunger.

According to the pipette device of the present invention, since the seal ring portion is formed on and integrally with one of the inner peripheral surface of the cylinder portion and the outer peripheral surface of the plunger, sealability between the pipette main body and the plunger can be ensured without requiring the conventional O-ring. This structure is adaptable to a decrease in diameter of the pipette main body, which has been difficult if the conventional O-ring is used, and can reduce cost because the O-ring is not necessary.

Further, the seal ring portion can be easily formed at the same time when the pipette main body or the plunger is manufactured, and in this respect as well, manufacturing cost can be reduced.

In a preferable embodiment of the present invention, the seal ring portion is formed to be elastically deformable.

According to the above preferable embodiment, since the seal ring portion is elastically deformable, it is possible to enhance sealability between the pipette main body and the plunger.

In another preferable embodiment of the present invention, the seal ring portions are formed in pair in the cylinder portion at a predetermined spaced interval, one of the seal ring portions having a horizontal section in a hemispherical shape, and the other seal ring portion having a horizontal section in a pointed shape.

According to the above another preferable embodiment, since one of the seal ring portions is in the hemispherical shape and the other seal ring portion is in the pointed shape, the hemispherical shape enables an increase in a sealing area to further enhance sealability. Further, if a sample should reach between the pipette main body and the plunger due to a suction negative pressure, the pointed shape can scrape off the sample, which can avoid the sucked sample from contaminating a driving mechanism and so on of the pipette device.

### BRIEF DESCRIPTION OF THE DRAWINGS

FIG. 1 and FIG. 2 are schematic views of a pipette device according to an embodiment 1 of the present invention;

FIG. 3 is a side sectional view of a pipette main body and a plunger of the pipette device;

FIG. 4 is a side sectional view of the pipette main body; and

FIG. 5 is an enlarged side sectional view of an essential part of the pipette device.

### DETAILED DESCRIPTION OF THE PREFERRED EMBODIMENT

Hereinafter, an embodiment of the present invention will be described based on the attached drawings.

### Embodiment 1

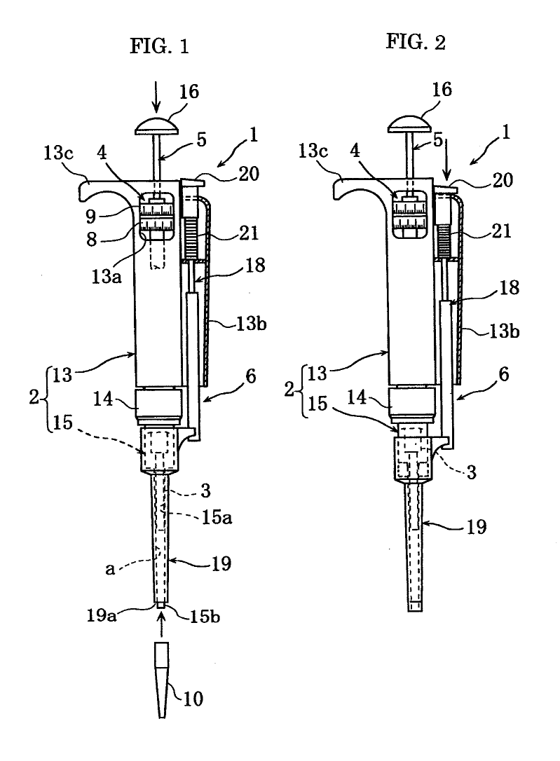

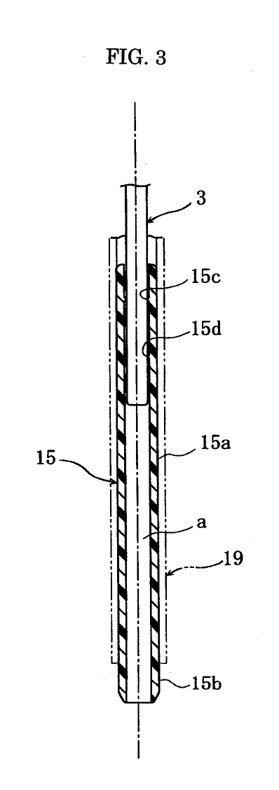

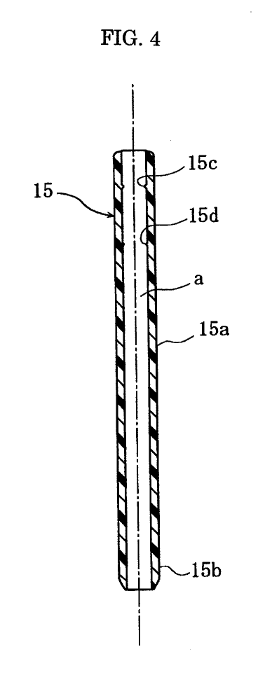

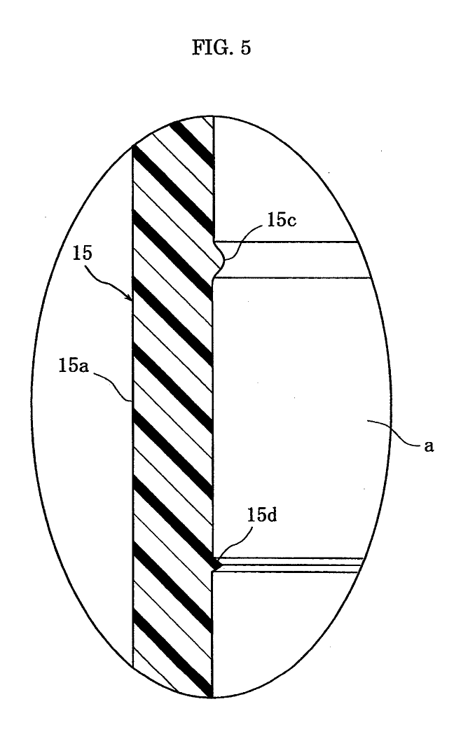

FIG. 1 to FIG. 5 are views for explaining a pipette device according to an embodiment 1 of the present invention.

In the drawings, reference numeral 1 denotes the pipette device for collecting a predetermined amount of a sample used for inspection, analysis, experiments, or the like.

The pipette device 1 includes: a pipette main body 2 having a cylinder portion “a”; a plunger 3 inserted in the cylinder portion “a” to be movable in an axial direction and changing a cylinder volume of the cylinder portion “a”; and a push rod 5 inserted in the pipette main body 2 to be rotatable and movable in the axial direction and moving the plunger 3 in the axial direction. Note that the cylinder volume practically means a stroke amount of the plunger 3.

The pipette device 1 has: a nut (not shown) unrotatably supported by the pipette main body 2 and converting the rotation of the push rod 5 to the axial-direction movement of the plunger 3; and a spring (not shown) constantly biasing the plunger 3 in a cylinder volume increasing direction.

An upper portion of the push rod 5 protrudes upward from an upper end of the pipette main body 2, and an operation knob 16 is attached to an upper end of the push rod 5. The plunger 3 moves in a cylinder volume reducing direction (downward) when the operation knob 16 is pressed down by a finger, and when the finger is detached next, the plunger 3 moves in the cylinder volume increasing direction (upward) due to a biasing force of the spring.

The pipette main body 2 is made of resin, and has: a housing 13 having a grip 13c; and a nozzle cone 15 detachably attached to a lower end portion of the housing 13 by a nut 14.

In the housing 13, first and second calibrated dials 8, 9 are disposed. The calibrated dials 8, 9 can be seen from a window 13a formed in the housing 13.

When the push rod 5 is rotated, the first calibrated dial 8 rotates and its graduation increases, and when the first calibrated dial 8 makes one rotation, the second calibrated dial 9 rotates by one graduation. Thus, the graduations of the calibrated dials 8, 9 change according to the number of rotations of the push rod 5, so that it is confirmed that the cylinder volume becomes a collection amount corresponding to the graduations.

The nozzle cone 15 is in a tapered shape that becomes thinner toward its tip, and has a cylinder main body 15a forming the cylinder portion “a” and a nozzle portion 15b continuously formed from the cylinder main body 15a. A pipette tip 10 storing the sample is attachably/detachably fitted to the nozzle portion 15b.

The pipette device 1 includes a pipette detaching mechanism 6 for detaching the pipette tip 10 that has been used. The detaching mechanism 6 has: a cover portion 13b provided on one side portion of the housing 13; an eject rod 18 reciprocatably disposed in the cover portion 13b; a return spring 21 biasing the eject rod 18 in a return direction; and an eject cone 19 engageably/disengageably coupled to a lower end portion of the eject rod 18. An eject button 20 is attached to an upper end of the eject rod 18.

The eject cone 19 is formed to surround an outer peripheral portion of the nozzle cone 15. A lower end 19a of the eject cone 19 is located near a lower end of the nozzle portion 15b and abbutably faces the pipette tip 10 fitted to the nozzle portion 15b.

The eject button 20, when pressed down by a finger, moves down the eject cone 19 via the eject rod 18, so that the used pipette tip 10 is pushed down to fall from the nozzle portion 15b of the nozzle cone 15.

A pair of upper and lower seal ring portions 15c, 15d slidably in contact with an outer peripheral surface of the plunger 3 is formed on and integrally with an inner peripheral surface of the cylinder portion “a” of the nozzle cone 15.

The seal ring portions 15c, 15d are formed to be elastically deformable. The seal ring portion 15c located on the upper side is formed to have a hemispherical horizontal section. On the other hand, the seal ring portion 15d located on the lower side is formed to have a horizontal section in a pointed shape of a triangle. With this structure, an area of the upper seal ring portion 15c in contact with the plunger 3 is large, while the lower seal ring portion 15d is substantially in line contact with the plunger 3.

To collect the sample by the pipette device 1, the pipette tip 10 is fitted to the nozzle portion 15b, and the stroke amount of the plunger 3, that is, the cylinder volume of the cylinder portion “a” is set by rotating the operation knob 16 by a finger. Then, the housing 13 is gripped and the operation knob 16 is pressed down by a thumb finger to move the plunger 3 to a lower end position in the cylinder volume reducing direction. In this state, a tip portion of the pipette tip 10 is immersed in the sample and the thumb finger is detached from the operation knob 16. Then, the plunger 3 moves up by the biasing force of the spring, so that a pressure in the cylinder portion “a” becomes negative, and the set amount of the sample is sucked and collected into the pipette tip 10. In order to inject the collected sample into a device for inspection, analysis, or the like, the operation knob 16 is pressed down while the pipette tip 10 is aligned with the inspection device or the like. Consequently, the plunger 3 moves down and the sample is injected into the inspection device or the like. Thereafter, the eject button 20 is pressed down to drop the used pipette tip 10 from the nozzle portion 15b.

According to this embodiment, since the pair of upper and lower seal ring portions 15c, 15d are formed on and integrally with the inner peripheral surface of the cylinder portion “a” of the nozzle cone 15, it is possible to ensure sealability between the nozzle cone 15 and the plunger 3 without using the conventional O-ring. This structure is adaptable to a decrease in diameter of the nozzle cone 15, which has been difficult if the conventional O-ring is used, and can reduce cost because the O-ring is not required.

Further, the seal ring portions 15c, 15d can be easily formed at the same time when the nozzle cone 15 is manufactured. In this respect as well, the cost of the sealing structure can be reduced.

In this embodiment, since the seal ring portions 15c, 15d are elastically deformable, it is possible to enhance sealability between the nozzle cone 15 and the plunger 3.

Further, since the seal ring portion 15c located on the upper side has a spherical shape, a sealing area between the nozzle cone 15 and the plunger 3 can be ensured. On the other hand, the seal ring portion 15d located on the lower side has a pointed shape, and therefore, if the sucked sample should reach the gap between the plunger 3 and the nozzle cone 15, the sample can be scraped off owing to the pointed shape.

In the embodiment described above, the seal ring portions 15c 15d are formed on the nozzle cone 15 of the pipette main body 2, but in the present invention, the seal ring portions may be formed on the plunger. This can also provide the same effects as those of the above-described embodiment.

Further, this embodiment describes the example where a liquid is collected by the single pipette device, but the present invention is also applicable to a pipette unit structured to collectively drive a large number of pipette devices. This can also provide the same effects as those of the above-described embodiment.

The invention may be embodied in other specific forms without departing from the spirit or essential characteristics thereof.

The present embodiments are therefore to be considered in all respects as illustrative and no restrictive, the scope of the invention being indicated by the appended claims rather than by the foregoing description, and all changes which come within the meaning and range of equivalency of the claims are therefore intended to be embraced therein.

The text of Japanese priority application No. 2010-010215 filed on Jan. 20, 2010, is hereby incorporated by reference.

What is claimed is:

1. A pipette device which includes: a pipette main body having a cylinder portion; a plunger disposed in an inserted state in the cylinder portion to be movable in an axial direction and changing a cylinder volume; and a push rod which is inserted in the pipette main body to be movable in the axial direction and moves the plunger to change the cylinder volume, the pipette device comprising:
a seal ring portion formed on and integrally with one of an inner peripheral surface of the cylinder portion and an outer peripheral surface of the plunger to seal a gap between the cylinder portion and the plunger.

2. The pipette device according to claim 1,
wherein said seal ring portion is formed to be elastically deformable.

3. The pipette device according to claim 1,
wherein the seal ring portions are formed in pair in the cylinder portion at a predetermined spaced interval, one of the seal ring portions having a horizontal section in a hemispherical shape, and the other seal ring portion having a horizontal section in a pointed shape.
